(19) United States
(12) Patent Application Publication
(10) Pub. No.: US 2009/0067936 A1
(43) Pub. Date: Mar. 12, 2009

(54) RASP HAND TOOL AND METHOD FOR USING SAME TO FORM AND SHAPE EXTERIOR INSULATION AND FINISH SYSTEM SURFACES

(76) Inventor: Jonathan Angelisanti, Deerfield Beach, FL (US)

Correspondence Address: MALIN HALEY AND DIMAGGIO, PA, 1936 S ANDREWS AVENUE, FORT LAUDERDALE, FL, 33316, US

(21) Appl. No.: 12/209,415

(22) Filed: Sep. 12, 2008

Related U.S. Application Data
(60) Provisional application No. 60/993,594, filed on Sep. 12, 2007.

(51) Int. Cl. B24D 15/00; G01C 9/00

(52) U.S. Cl. 407/29.15; 33/354; 7/163; 52/741.1

(57) ABSTRACT

An improved combination level and rasp tool particularly adapted for use in forming, shaping, and smoothing, EIFS surfaces is disclosed. A combination level and rasp tool includes an elongate frame having at least one level mounted thereto, a pair of spaced elongate hand hold apertures formed therein, and an elongate saw tooth rasp blade removably mounted to the frame and angularly disposed relation therewith. The upper portion of the frame preferably defines an angularly disposed elongate slot for receiving the rasp blade and suitable fasteners are provided for securely affixing the rasp blade. The rasp blade is configured to project angularly upward for ease of use.

### CROSS REFERENCE TO RELATED APPLICATIONS

This application claims the benefit of provisional U.S. Patent Application No. 60/993,594, filed Sep. 12, 2007.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to hand tools, and more particularly to a rasp hand tool particularly suited for use in forming and sculpting exterior insulation and finish systems.

2. Description of Related Art

Exterior Insulation and Finish Systems (EIFS) are multi-layered exterior wall systems that are used on both commercial buildings and homes. EIFS provide superior energy efficiency and offer greater design flexibility than other cladding products. Developed in Europe in the 1950s, EIFS were introduced in the U.S. almost 30 years ago. They were first used on commercial buildings, and later, on homes. Today, EIFS account for nearly 30% of the U.S. commercial exterior wall market. The growing popularity of EIFS is due to the fact that few, if any, competitive materials offer such a wide range of desirable product benefits. Chief among these are superior energy efficiency and virtually unlimited design flexibility.

The appearance of EIFS bears a resemblance to stucco or stone, but the systems are far more versatile than these and other materials. Not only do EIFS come in virtually limitless colors and a wide variety of textures, but they also can be fashioned into virtually any shape or design. With EIFS, skilled applicators can create all sorts of exterior architectural detailing that would often be cost-prohibitive using conventional construction.

The components of EIFS typically include (a) an insulation board; (b) an attachment of the insulation board to the substrate or existing wall surface; (c) a base coat reinforced with glass mesh on the face of the insulation board; and (d) a finish coat in a variety of colors and textures designed to protect the entire system. The actual material of the EIFS is expanded polystyrene (EPS), a light weight, resilient, foamed plastic compound that can be molded to meet specific application requirements.

When the EPS is installed on an exterior wall, extensive sanding and leveling operations must be performed over the entire wall surface. These manual operations are tedious and time-consuming. Close attention to detail is required in taking the level measurements while, at the same time, long sweeping motions are needed in the sanding. Both prefabricated EIFS panels and field-applied EIFS panels require these combined activities. In addition, extra care and attention are needed at caulk joints and at wall and floor edges. Any tool that would improve the process and technique for sanding and taking level measurements would be beneficial.

Accordingly, there exists a need for an improved tool adapted for use in shaping and forming EIFS. U.S. Pat. No. 6,434,842, issued to Cruz discloses a rasping level for leveling a flat surface while removing irregularities in the surface by sanding. The rasping level consists of a frame adapted with levels positioned on the top surface and sandpaper on the opposite surface. While the rasping tool disclosed by Cruz is somewhat effective in removing minor irregularities, the use of sand paper limits the effectiveness of the tool. In addition, the rasping level disclosed by Cruz includes grippers that are relatively small, difficult to grasp, and place excessive strain on the users hands. Accordingly, there exists a need for an improved rasp tool particularly adapted for use with EIFS systems.

### BRIEF SUMMARY OF THE INVENTION

The present invention overcomes the limitations and disadvantages present in the art by providing an improved combination level and rasp tool particularly adapted for use in forming, shaping, and smoothing, EIFS surfaces. A combination level and rasp tool in accordance with the present invention includes an elongate frame having at least one level mounted thereto, a pair of spaced elongate hand hold apertures formed therein, and an elongate saw tooth rasp blade removably mounted to the frame and angularly disposed relation therewith. The upper portion of the frame preferably defines an angularly disposed elongate slot for receiving the rasp blade and suitable fasteners are provided for securely affixing the rasp blade. The rasp blade is configured to project angularly upward for ease of use.

Accordingly, it is an object of the present invention to provide an improved tool for forming, shaping, and smoothing EIFS surfaces.

Another object of the present invention is to provide an improved combination level and rasp tool for use in forming EIFS surfaces.

Still another object of the present invention to provide such a tool wherein the rasp blade is angularly mounted to the frame for ease of use.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a top exploded perspective view of a combination level and rasp hand tool in accordance with the present invention;

FIG. 2 is a partial detail view of the rasp blade;

FIG. 3 is a top perspective view of the combination level and rasp tool;

FIG. 4 is an end view thereof;

FIG. 5 is an exploded top perspective view of an alternate embodiment combination level and rasp hand tool;

FIG. 6 is a top perspective view thereof, and

FIG. 7 is an end view thereof.

### DETAILED DESCRIPTION OF THE INVENTION

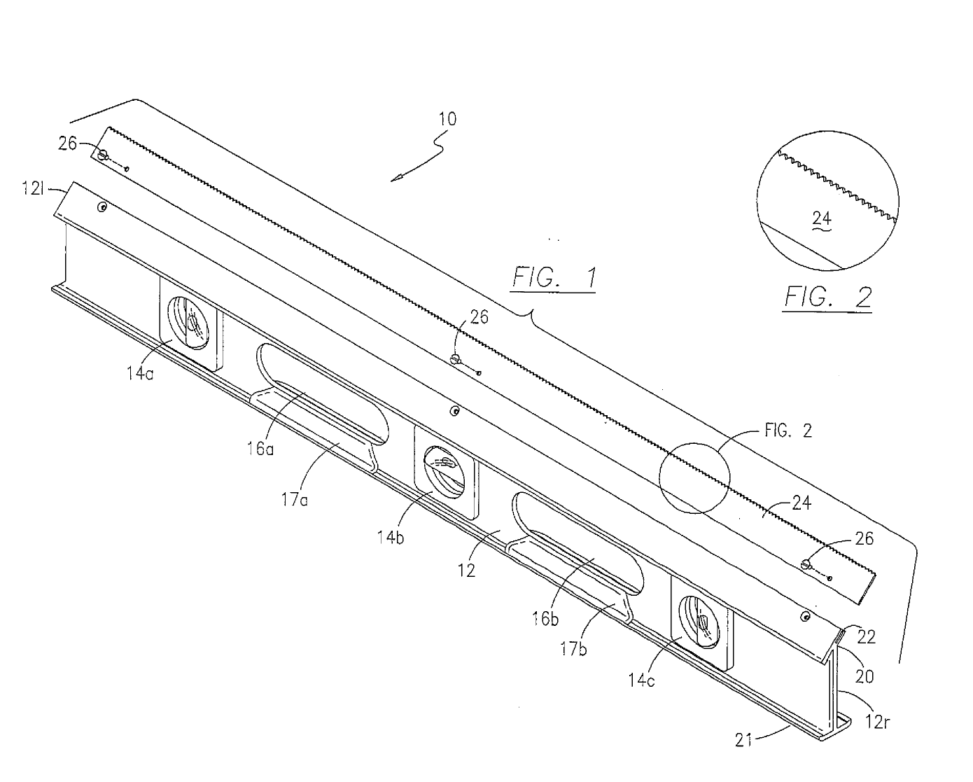

With reference to the drawings, FIGS. 1-4 depict an improved combination level and rasp tool, generally referenced as 10, in accordance with the present invention for use in forming, shaping, and smoothing, EIFS surfaces. Rasp tool 10 includes an elongate rigid frame member 12 having a left end 12l and a right end 12r. Frame member 12 is preferably fabricated from lightweight aluminum or composite material, however any suitable material is considered within the scope of the present invention. Frame member 12 includes a plurality of level members, referenced as 14a, 14b, and 14c, securely affixed thereto to allow the user to quickly determine horizontal and vertical orientations. As should be apparent, level members 14 may be oriented generally vertically, horizontally, and/or at a suitable angle. Frame member 12 further defines a pair of elongate slotted apertures, referenced as 16a and 16b that function to allow the user's hands to securely hold rasp tool 10 when in use. Frame member 12 is preferably ergonomically shaped having rounded portions, referenced as 17a and 17b, on the lower side of slotted apertures 16a and 16b to provide a comfortable surface for grasping. Rounded portions 17a and 17b may comprise resilient material to further aid in providing a comfortable gripping surface. In an alternate embodiment, frame member 12 does not include slotted apertures 16 thereby providing an alternate structure that may provide easier gripping and manipulation.

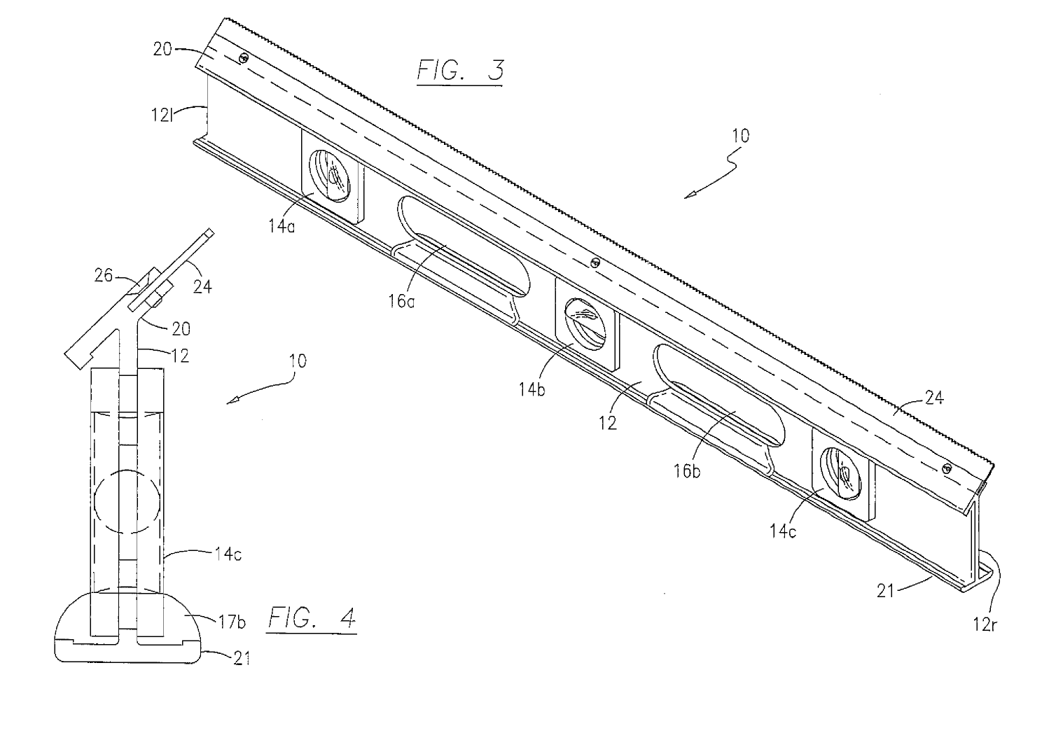

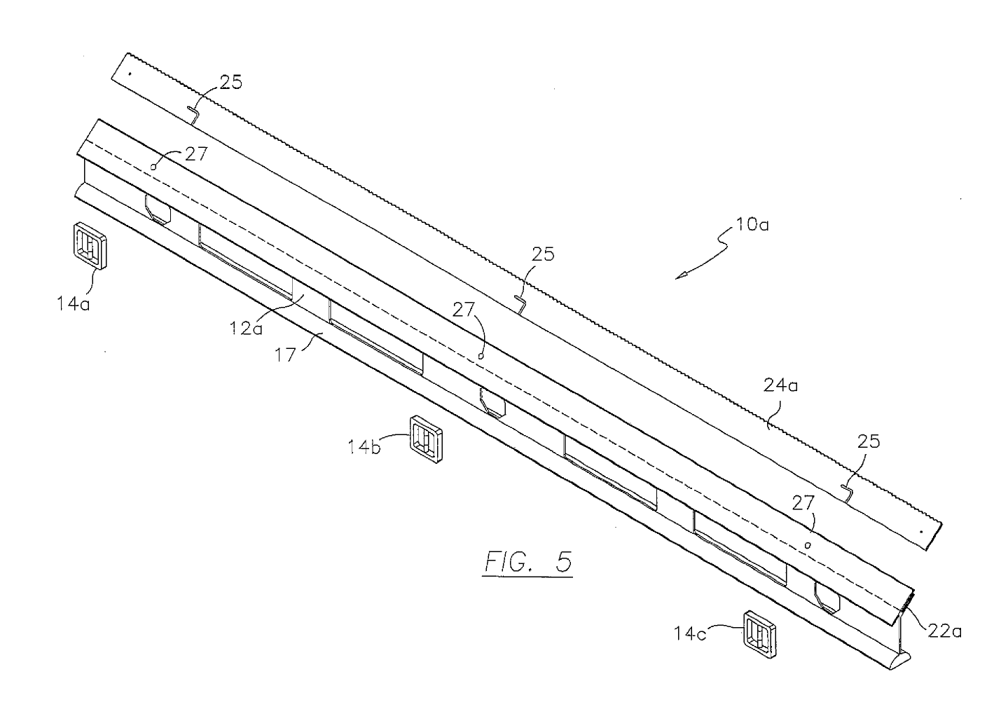

Rasp tool 10 further includes an angularly disposed top portion, generally referenced as 20, and a bottom 21. As best seen in FIG. 4, bottom 21 preferably comprises a generally planar base disposed perpendicular frame 12. Top portion 20 defines an elongate blade mount defining a slot 22 sized for receiving at least a potion of a saw tooth rasp blade 24 therein. Rasp blade 24 is preferably fabricated from preferably includes at least one lengthwise edge defining saw tooth pattern for use in scraping EIFS surfaces. It has been found that having rasp blade 24 disposed at an upward angle significantly eases use by allowing the user to clearly view the blade edge while allowing EIFS material to be removed with great accuracy using ergonomic motion. As illustrated in FIGS. 1 and 3, rasp blade 24 is removably received within slot 22 and securely affixed relative to frame member 12 by a plurality of threaded fasteners 26 in the preferred embodiment. In an alternate embodiment, blade 24 may be secured to top portion 20 with removable clips (not shown).

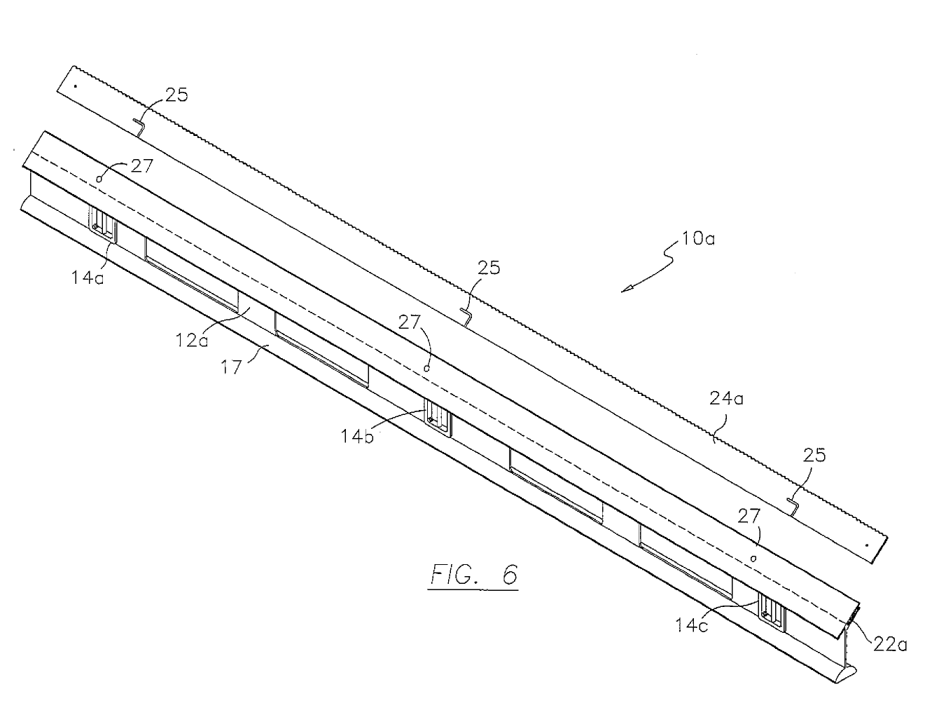

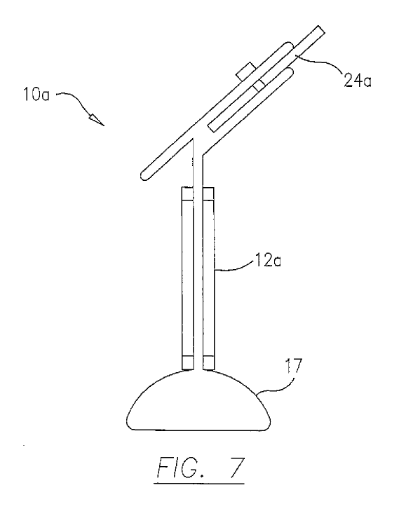

FIGS. 5-7 depict an alternate embodiment rasp tool, referenced as 10a. Alternate embodiment rasp tool 10a, is similar in structure to the embodiment illustrated in FIGS. 1-4. Rasp tool 10a, however, includes a base, referenced as 17 which defines a convex top portion and generally planar bottom portion along the entire length of frame member 12a. In addition, rasp tool 10a includes an alternate structure rasp blade, referenced as 24a. Rasp blade 24a defines L-shaped slotted apertures 25 for mating engagement with fixed pins 27 within slot 22a of top portion 20a to allow the blade to be inserted by movement downward into slot 22 followed by lateral movement whereafter the blade may be secured by fasteners. The present invention, however, contemplates alternate mounting configurations including snap fit, and lever actuated or cam latch fastening.

As noted above, top portion 20 is angularly disposed relative to frame member 12 such that mounted rasp blade 24 projects generally angularly upward therefrom. In a preferred embodiment top portion 20 is disposed such that rasp blade 24 projects from the top 20 of frame member 12 at approximately a 45-degree angle. As should be apparent, suitable angular variations are considered within the scope of the present invention. It has been determined that mounting rasp blade 24 in such an angularly projecting orientation provides a significant advantage over other possible mounting configurations such as right angled or vertically upward configurations. More particularly, mounting rasp blade 24 in an angular configuration reduces strain on the user's hands and arms and further provides an optimal line of sight to allow the user to best visualize engagement of rasp blade 24 with the EIFS surface being formed.

As should now be apparent, rasp tool 10 is useful in forming, shaping, and smoothing EIFS surfaces, particularly the EPS surfaces associated with EIFS. The user grasps rasp tool 10 by placing his hands through elongate slotted apertures 16A and 16B and positions the tool such that rasp blade 24 engages the desired EIFS surface. The user then selectively manipulates tool 10 in such that rasp blade 24 scrapes away EIFS material until the desired form, shape, and/or smoothness are achieved. As should further be apparent, levels 14A, 14B, and 14C, function to enable the user to form horizontal and vertical lines and forms in the EIFS without having to change tools.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A rasp hand tool for forming, shaping, and smoothing surfaces, said hand tool comprising:
an elongate rigid frame having a top, a bottom, and left and right opposing ends;
at least one level mounted to said frame;
said frame top including an upwardly angularly disposed blade mount; and
a rasp blade removably affixed to said blade mount.

2. A rasp hand tool according to claim 1, wherein said frame defines a pair of elongate slotted apertures that function to allow the user's hands to securely hold the hand tool.

3. A rasp hand tool according to claim 1, wherein said blade mount is disposed at approximately 45-degrees relative to said frame.

4. A rasp hand tool according to claim 1, wherein said frame bottom includes rounded portions formed of resilient material that further aid in providing a comfortable gripping surface.

5. A rasp hand tool for forming, shaping, and smoothing exterior insulation and finish systems material, said apparatus comprising:
an elongate rigid frame having a top, a bottom, and left and right opposing ends;
at least one level mounted to said frame;
said frame top including an upwardly angularly disposed blade mount;
said blade mount including a longitudinal slot and at least one anchor pin removably disposed within said slot;
an elongate rasp blade removably affixed to said blade mount and secured angularly upward relative to said frame top, said rasp blade defining at least one slot disposed generally transversely relative to the length of said rasp blade for receiving said at least one anchor pin; and
means for fixing said rasp blade to said blade mount.

6. A rasp hand tool according to claim 1, wherein said means for fixing said rasp blade includes a threaded fastener.

7. A rasp hand tool according to claim 1, wherein said means for fixing said rasp blade includes a clip.

8. A method of forming, shaping, and smoothing EIFS surfaces, said method comprising:
providing a rasp hand tool having an elongate rigid frame having a top, a bottom, and left and night opposing ends, and at least one level mounted to said frame, said frame top including an upwardly angularly disposed blade mount with a rasp blade removably affixed to said blade mount;
grasping said rasp hand tool and manipulating same over an EIFS surface such that said rasp blade selectively removes EIFS material.
